(19) United States
(12) Patent Application Publication
(10) Pub. No.: US 2023/0159163 A1
(43) Pub. Date: May 25, 2023

(54) Rotary aircraft and interactive method of the same

(71) Applicant: Keke TongMan(Shenzhen) Co., LTD., Shenzhen (CN)

(72) Inventor: Lijun Tao, Shenzhen (CN)

(21) Appl. No.: 17/540,265

(22) Filed: Dec. 2, 2021

(30) Foreign Application Priority Data
Nov. 19, 2021 (CN) 202111399329.6

(51) Int. Cl. B64C 39/02; A63H 27/00

(52) U.S. Cl. CPC B64C 39/024; A63H 27/12; A63H 30/02

(57) ABSTRACT

A rotary aircraft includes a cover, a driving shaft in the cover, an electric control board on the cover, and a flight assembly mounted on the driving shaft and coupled electrically with the electrical control board, a driving assemble mounted on the flight assembly and coupled electrically with the electrical control board, connected with the driving shaft and driving it to rotate so as to rotate the cover, and a light bar mounted on the cover and coupled electrically with the electrical control board, used for displaying a presetting pattern or text, which achieves enlightening education and improves enjoyment of the flight toy and satisfies the demands of the users.

### FIELD OF THE INVENTION

The present invention relates to aircraft technical field, more particularly relates to a rotary aircraft and interactive method of the same.

### BACKGROUND OF THE INVENTION

As people's living standards improve, the demands for toys are getting higher and higher, and flying toys emerge at the moment. Chinese Utility Model No. 201721262985.0 discloses a LED spherical display with an unmanned aerial vehicle assemble, which includes a frame, a display module, an unmanned aerial vehicle assemble, and a power assemble. The display module is fixed in the frame, the unmanned aerial vehicle assemble and a power assemble are provided in the display module. The unmanned aerial vehicle assemble drives the frame, and the display module and the power assemble in the frame to fly. The power assemble drive the display module to fly in its own axis.

Although the LED spherical display with an unmanned aerial vehicle assemble disclosed in the above patent can fly and project, its huge volume, and the limitation in the structure design result in the deficiencies such as not suitable for enlightening the children, lacking of enjoyments, which can not satisfy the user's demands for the flying toy.

### SUMMARY OF THE INVENTION

The object of the present invention is to provide a rotary aircraft around its axis and interactive method of the same, which resolves the technical problems that flight toys can not meet the users' demands.

To achieve the above object, the present invention provide a rotary aircraft, which includes a cover, a driving shaft in the cover, an electric control board on the cover, and a flight assembly mounted on the driving shaft and coupled electrically with the electrical control board, a driving assemble mounted on the flight assembly and coupled electrically with the electrical control board, connected with the driving shaft and driving it to rotate so as to rotate the cover, and a light bar mounted on the cover and coupled electrically with the electrical control board, used for displaying a presetting pattern or text.

The rotary aircraft also includes a signal transmitting element and a signal receiving element both coupled electrically with the electrical control board. The signal transmitting element can be mounted on the cover, the light bar or the fight assemble, the signal receiving element is mounted on the fight assemble.

Optionally, the electrical control board is provided with a control circuit which is coupled electrically with all of the light bar, the signal transmitting element, the signal receiving element, the flight assemble and the driving assemble. A surface, facing to the flight assemble, of the electrical control board is provided with a continuous conductive unit and an intermittent conductive unit, both coupled electrically with the control circuit. The continuous conductive unit is matched with a first elastic conductive unit, when the cover drives the electric control board to rotate a circle, the first elastic conductive unit is against with the continuous conductive unit. The intermittent conductive unit is matched with a second elastic conductive unit, when the cover drives the electric control board to rotate a circle, the second elastic conductive unit contacts the intermittent conductive unit at least once. The first elastic conductive unit and the second elastic conductive unit both are mounted in the flight assemble and are coupled with a supply power mounted on the flight assemble.

Optionally, the electrical control board is provided with a control circuit which is coupled electrically with all of the light bar, the signal transmitting element, the signal receiving element, the flight assemble and the driving assemble. The light bar is provided with a power supply element and a signal receiving circuit, and the power supply element is coupled electrically with the signal receiving circuit and supplies it. The signal receiving circuit and the control circuit are communication connection.

Optionally, the rotary aircraft also includes a connector mounted on a side of the flight assemble, both of the first elastic conductive unit and the second elastic conductive unit are mounted a connector.

Optionally, the connector includes a mounting plate and a connecting rod with a first end and a second end. The first end of the connecting rod is connected with the outside of the flight assemble, the second end of the connecting rod is connected with the mounting plate. The mounting plate is provided with a first mounting position where the first electrical conductive unit is mounted and a second mounting position where the second electrical conductive unit is mounted.

Optionally, two ends of the driving shaft are connected respectively with an inner wall of the cover. The driving shaft is also fixed with a drive gear, driven by the driving assemble. An inner side of the drive gear is against with another side of the flight assemble.

Optionally, the driving shaft passes longitudinally across the flight assemble.

Optionally, the driving shaft passes transversely across the flight assemble.

Optionally, the light bar includes multiple display lights, each coupled electrically to the control circuit, each disposed toward the exterior of the cover.

The above one or more of the rotary aircraft provided in embodiments of the present invention have at least one of the following technical effects:

When the rotary aircraft is used, the rotary aircraft is thrown out, the flight assemble is started, the rotary aircraft self-steadily flies according to a throwing angel, simultaneously, the driving assemble drives the driving shaft to rotate so as to drive the cover to rotate, the flight process, the force generated by the rotation of the cover balances the flight force of the flight assemble to achieve a stable flight. The light bar rotates with the cover and projects the presetting pattern or text to achieve enlightening education and improve the enjoyment of the flight toy and satisfy the demands of the users.

To achieve the above object, the present invention also includes an interactive method if the rotating aircraft, which includes the following steps:

Step S100, the flight assemble starts to drive the cover to fly, simultaneously, the driving assemble starts to drive the driving shaft to rotate so as to rotate the cover.

Step S200, the signal transmitting element sends a sensing signal to the outside of the cover.

Step S300, the signal receiving element receives at least two triggering signals sent by at least one user and sends the two triggering signals to the electrical control board, wherein, each of the triggering signals is the reflected signal that the sensing signal is sent to the user and reflected to the signal receiving element, at least two of the triggering signals are reflected to the signal receiving element at the same time point or in a specific time.

Step S400: the electrical control board controls the light bar to display the presetting pattern and text according to the triggering signals or control the flight assemble to change the flight attitude.

The above one or more of the rotary aircraft provided in embodiments of the present invention have at least one of the following technical effects:

When the signal receiving element receives at least two of the triggering signals sent by at least one user, the electrical control board controls the lighter bar to display the presetting pattern and text, the triggering signals can be generated by a user to waving his two hand respectively or by the user to wave one hand continuously in a specific time, or two or more users to generate one triggering signal respectively at the same time, so that the interaction with the aircraft can be achieved by more actions of one user and the simultaneous actions of multiple users, which improves the enjoyment of the rotary aircraft and satisfy the demands of the user.

### BRIEF DESCRIPTION OF THE DRAWINGS

In order to more clearly illustrate the technical schemes in the embodiments in the present invention, the drawings needed in the embodiments or the prior technical description are briefly introduced below. Obviously, the drawings described below are only some embodiments in the present invention, and for those skilled in the art, additional drawings may be obtained according to the drawings below without creative work.

FIG. 1 is a perspective view of the rotary aircraft in accordance to an embodiment of the present invention.

FIG. 2 is a decomposition view of the rotary aircraft in accordance to an embodiment of the present invention.

FIG. 3 is a perspective view of the rotary aircraft removing the cover in accordance to an embodiment of the present invention.

FIG. 4 is another perspective view of the rotary aircraft removing the cover in accordance to an embodiment of the present invention.

FIG. 5 is a decomposition view of the flight assemble, the connector and the electrical control board of rotary aircraft in accordance to an embodiment of the present invention.

FIG. 6 is the other decomposition view of the flight assemble, the connector and the electrical control board of rotary aircraft in accordance to an embodiment of the present invention.

FIG. 7 is a perspective view of the rotary aircraft removing the cover in accordance to the other embodiment of the present invention.

FIG. 8 is a perspective view of the light bar of the rotary aircraft in accordance to the other embodiment of the present invention.

FIG. 9 is a flow view of an interactive method based on a rotary aircraft in accordance to the other embodiment of the present invention.

### DETAILED DESCRIPTION OF ILLUSTRATED EMBODIMENTS

In order to make the invention purpose, the technical scheme and the technical effect more clearly be understood, the invention is further explained in combination with the concrete embodiment below. It should be understood that the specific embodiments described herein are only used to interpret the invention and are not used to limit the invention.

Embodiments of the present invention are described in detail below, and examples of the embodiments are shown in the attached drawings, in which the same or similar labels represent the same or similar elements or elements with the same or similar function. The embodiments described below by reference to the attached drawings are exemplary and are intended to explain embodiments of the present invention and cannot be understood as limits in the present invention.

In the description of the embodiments of the present invention, it should be understood that the directional indications involved in the embodiments, such as the “upper”, “lower”, “left”, “right”, “front”, “rear”, “internal” and “external”, indicating orientation or location relationship, are based on the orientation or position relationship showed in the figures. These directional indications are only for describing the embodiments in the present invention and simplifying the description, rather than indicating or implying that the device or the element must be constructed and operated in a specified azimuth, which cannot be understood as a limitation of the present invention.

Further, the terms “first”, and “second” are used only for description purposes, and cannot be understood as indicating or implying relative importance or implicitly indicating the number of technical features indicated. Thus, features defining “first” and “second” may expressly or implicitly include one or more of the features. In the description of the embodiments of the present invention, the “plurality of” means two or more unless otherwise specifically limits.

In the embodiments of the invention, unless otherwise clearly specified and defined, the terms, “installed”, “connected”, “or “fixed” should be generally understood, for example, a fixed connection, or a removable connection, a mechanical connection or an electrical connection, or an directly connection or an indirectly connection through an intermediate media, or a connection within two elements or the interaction of two elements. For those of ordinary skilled in the art, the specific meaning of the above terms in the embodiment of the present invention may be understood under specific circumstances.

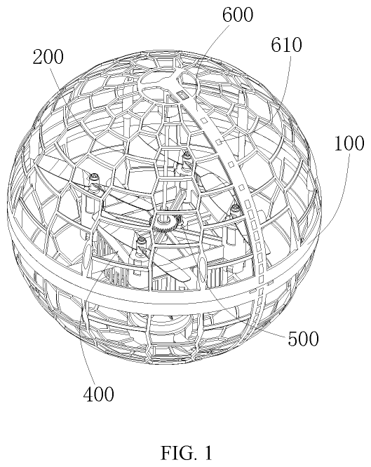

Referring to FIG. 1 to FIG. 3, in accordance to an embodiment of the present invention, the present invention provide a rotary aircraft, which includes a cover 100, a driving shaft 200 in the cover 100, an electric control board 300 on the cover 100.

The rotary aircraft also includes a flight assembly 400 mounted on the driving shaft 200 and coupled electrically with the electrical control board 300, a driving assemble 500 mounted on the flight assembly 40 and coupled electrically with the electrical control board 300, connecting with the driving shaft 200 and driving it to rotate so as to rotate the cover 100, and a light bar 600 mounted on the cover 100 and coupled electrically with the electrical control board 300, used for displaying a presetting pattern or text.

The number of the light bar 600 is at least one such as eight, eight of the light bars 600 are uniformly disposed in the cover 100 to improve the display effect.

In use, the rotary aircraft is thrown out at a throwing angel, the flight assemble 400 is started to drive the rotary aircraft to self-steadily fly according to the throwing angel, simultaneously, the driving assemble 500 drives the driving shaft 200 to rotate so as to drive the cover 100 to rotate. In the flight process, the force generated by the rotation of the cover 100 balances the flight force of the flight assemble 400 to achieve a stable flight. The light bar 600 rotates with the cover 100 and projects the presetting pattern or text to achieve enlightening education and improve the enjoyment of the flight toy and satisfy the demands of the users.

The electrical control board 300 is provided with a control program, based on which the electric control board 300 controls the driving assemble 500 and the flight assemble 400.

The rotary aircraft also includes an acceleration transducer coupled electrically with the electrical control board 300 and mounted on the electrical control board 300 or the flight assemble 400. The acceleration transducer sends a reflected signal to the electrical control board 300, the electrical control board 300 controls the flight assemble 400 to start and achieve the flight control of the flight assemble 400.

Referring to FIG. 1 to FIG. 3, The rotary aircraft also includes a rotary electric motor 510 driving the shaft 200 to rotate.

Referring to FIG. 1 to FIG. 3 and FIG. 4, in accordance to an embodiment of the present invention, the rotary aircraft also includes a signal transmitting element 710 and a signal receiving element 720 both coupled electrically with the electrical control board 300. The signal transmitting element 710 can be mounted on the cover 100, the light bar 600 or the fight assemble 400. The signal receiving element 720 is mounted on the fight assemble 400. The number of the signal transmitting element 710 is at least one.

The signal transmitting element 710 is an infrared transmitting tube, the signal receiving device 720 is an infrared receiving tube. In flights, the rotary aircraft transmits sensing signal by the infrared transmitting tube, receives the reflected signal, reflected after the sensing signal meets the obstacle, by the infrared receiving tube thereby realizing the obstacle avoidance function of the rotary aircraft and improving the safety and reliability of the rotary aircraft.

In accordance to an embodiment of the present invention, the electrical control board is provided with a control circuit which is coupled electrically with all of the light bar 600, the signal transmitting element 710, the signal receiving element 720, the flight assemble 400 and the driving assemble 500.

Referring to FIG. 1 to FIG. 3 and FIG. 6, a surface, facing to the flight assemble 400, of the electrical control board 300 is provided with a continuous conductive unit 310 and an intermittent conductive unit 320, both coupled electrically with the control circuit. The continuous conductive unit 310 is matched with a first elastic conductive unit 810, when the cover 100 drives the electric control board 300 to rotate, the first elastic conductive unit 810 is always against with the continuous conductive unit 810. The intermittent conductive unit 320 is matched with a second elastic conductive unit 820, when the cover 100 drives the electric control board 300 to rotate a circle, the second elastic conductive unit 820 contacts the intermittent conductive unit 320 at least once. The first elastic conductive unit 810 and the second elastic conductive unit 820 both are mounted in the flight assemble 400 and are coupled with a supply power mounted on the flight assemble 400.

The supply power is a rechargeable battery or a non-rechargeable battery, the electric power of the power supply device can supply to the electric control board 300 by the first elastic conductive unit 810, the second elastic conductive unit 820, the intermittent conductive unit 320 and the continuous conductive unit 310. Then the electric control board 300 supplies for the light bar 600.

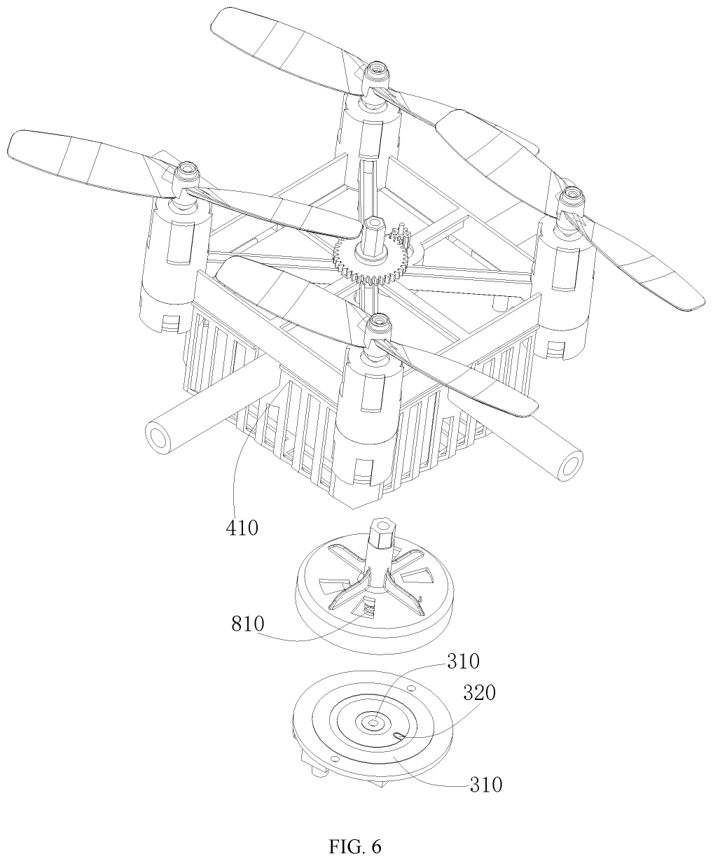

The number of the continuous conductive portion 310 is at least one, in accordance to an embodiment of the present invention, referring to FIG. 6, the number of the continuous conductive portion 310 is two, the shape of the two continuous conductive portions 310 may be the same of different. For example, one of them is set in ring shape, the other of them is set in a circle. Or, the number of the continuous conductive portion 310 may be greater than two, and the shape may be set as desired.

In accordance to an embodiment of the present invention, the number of the intermittent conductive unit 320 is at least one. When the number of the intermittent conductive unit 320 is one, the cover 100 drives the electric control board 300 to rotate a circle, the second elastic conductive unit 820 contacts the intermittent conductive unit 320 once. The control circuit includes a main control chip with one I/O port coupled electrically with the intermittent conductive unit 320, the second elastic conductive unit 820 contacts the intermittent conductive unit 320 once, that is triggering the I/O port once. The main control chip obtains the information about the number of the rotary circles of the cover 100 by the number of that the second elastic conductive unit 820 triggers the I/O port, thereby obtaining a speed information of the cover 100, so that the main control chip controls the cover to rotate uniformly according to the speed information, simultaneously control the pattern of the light bar 600 to synchronize with the speed information to ensure clarity and accuracy of the displayed content.

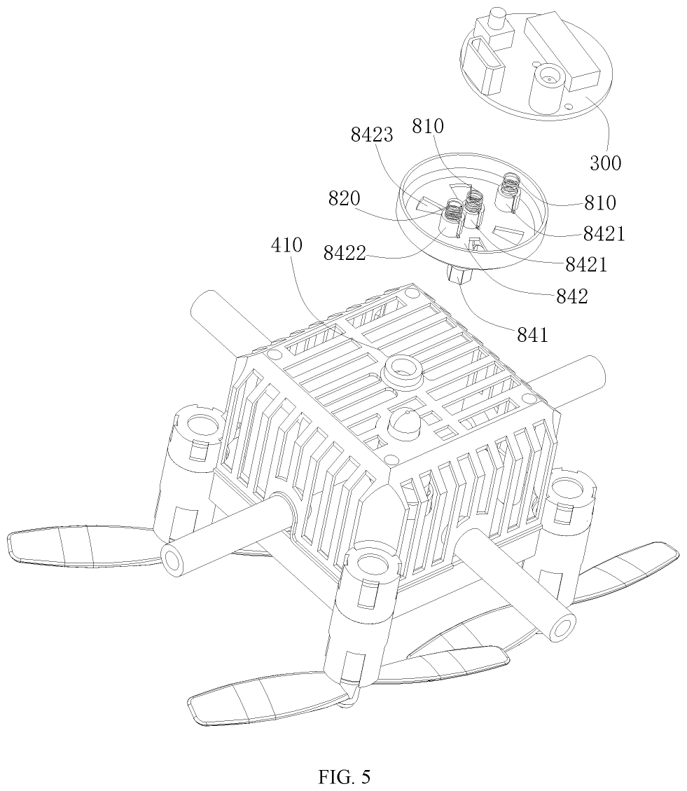

Referring to FIG. 5, the first elastic conductive unit 810 and the second elastic conductive unit 820 are elastic parts such as compression spring. On one hand, the compression spring can deform to keep the conductive contact to the intermittent conductive unit 320 and the continuous conductive portion 310 when the cover 100 rotates, on the other hand, one end of the compression spring contacts the surface of the electric control board 300, the other end of the compression spring contacts the flight assemble 400, thereby supporting it.

The first elastic conductive unit 810 corresponds with the continuous conductive portion 310. Referring to FIG. 5 and FIG. 6, if the number of the continuous conductive portion 310 is two, the number of the first elastic conductive unit 810 is also two, and the position of the first elastic conductive unit 810 corresponds with that of the continuous conductive portion 310.

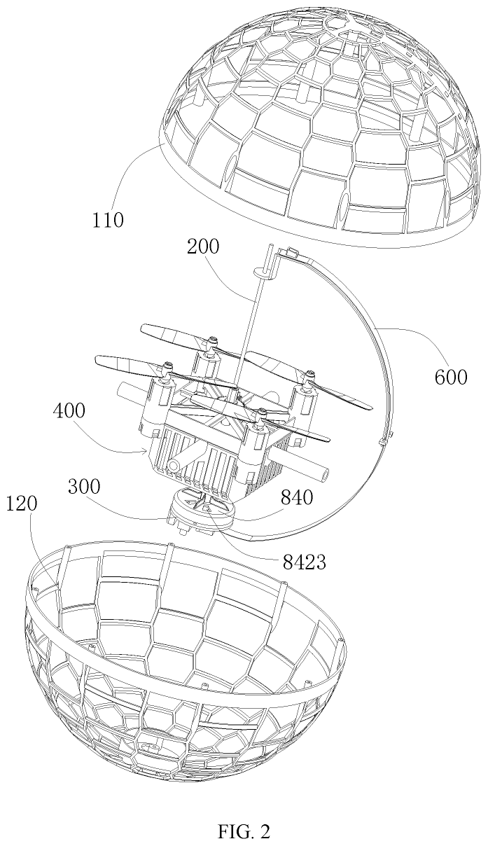

In accordance to an embodiment of the present invention, referring to FIG. 1 and FIG. 2, the aircraft also includes a connector 840 mounted on a side of the flight assemble 400, both of the first elastic conductive unit 810 and the second elastic conductive unit 820 are mounted a connector 840.

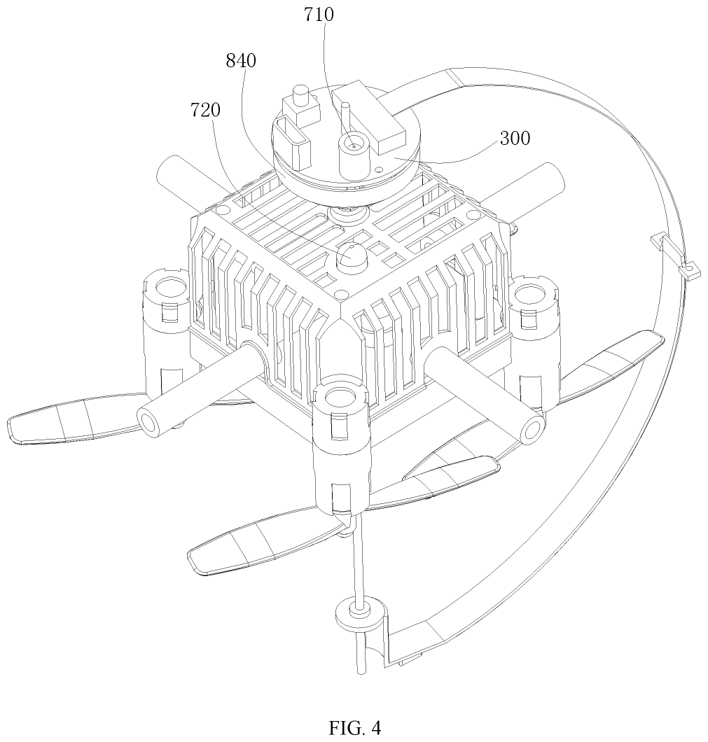

Referring to FIG. 4 and FIG. 6, the connector 840 includes a mounting plate 842 and a connecting rod 841 with a first end and a second end. The first end of the connecting rod 841 is connected with the outside of the flight assemble 400, the second end of the connecting rod 841 is connected with the mounting plate 842. The mounting plate 842 is provided with a first mounting position 8421 where the first electrical conductive unit 810 is mounted and a second mounting position 8422 where the second electrical conductive unit 820 is mounted.

The connecting rod 841 is hollow inside, the driving shaft 200 passes through the connecting rod 841 and can rotate in it. When the driving shaft 200 is rotating, the connecting rod 841 is not rotating.

The first electrical conductive unit 810 and the second electrical conductive unit 820 are fixed on the mounting plate 842 respectively with a part passing through the mounting plate 842 so as to coupled electrically to the supply power with a cable.

Or, the mounting plate 842 is provided with an avoiding hole 8423 to facilitate setting a cable, with one end coupled electrically with the first conductive unit 810 and the second conductive unit 820, the other end passing the avoiding hole 8423 and coupled electrically with the supply power.

The mounting rod and the connecting plate are integrated molding.

In accordance to an embodiment of the present invention, the light bar 600 is independently power supply, that is to say, the light bar 600 is provided with a power supply 640 which can be a battery chosen by those skilled in the art. The power supply 640 also can be arranged on the cover 100.

The communication between the light bar 600 and the control circuit is wireless connected, that is to say, the light bar 600 and the electrical control board 300 are connected without wireless, the electrical control board 300 control the light bar 600 to display with a wireless method.

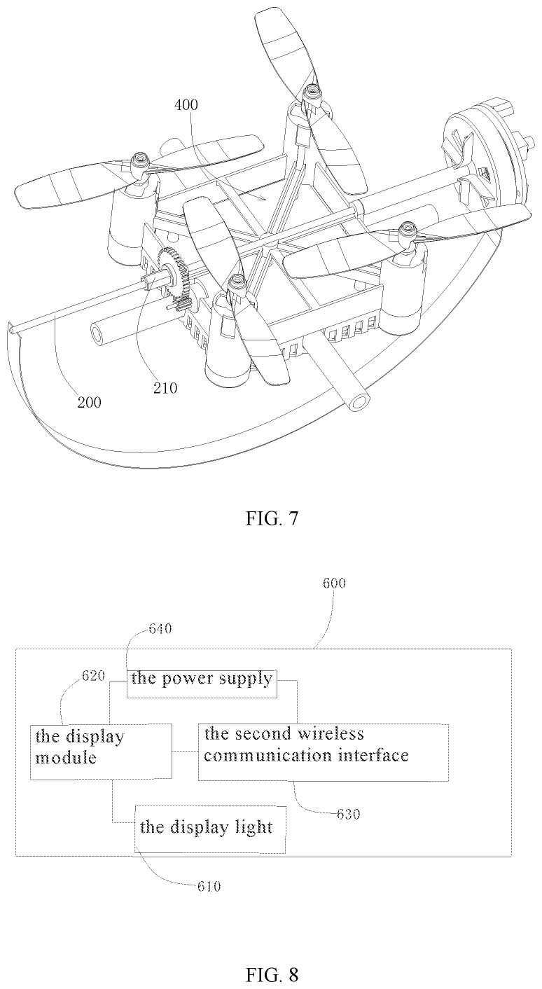

Specifically, referring to FIG. 7, the electrical control board 300 is provided with a first wireless communication interface coupled electrically with the control circuit. The light bar 600 is provided with a display control module 620 and a second wireless communication interface 630 coupled electrically with the display control module 620. The power supply 640 supplies power for the display control module 620 and the second wireless communication interface 630. The second wireless communication interface 630 and the first wireless communication interface are matched with each other to realize communication connection.

Specifically, the first wireless communication interface and the second wireless communication interface 630 is provided to matching interfaces for magnetic, optical, infrared or other wireless non-contact communication, thereby ensuring one-way or two-way wireless communication between the control circuit and the display control module 620 through the first wireless communication interface and the second wireless communication module 620.

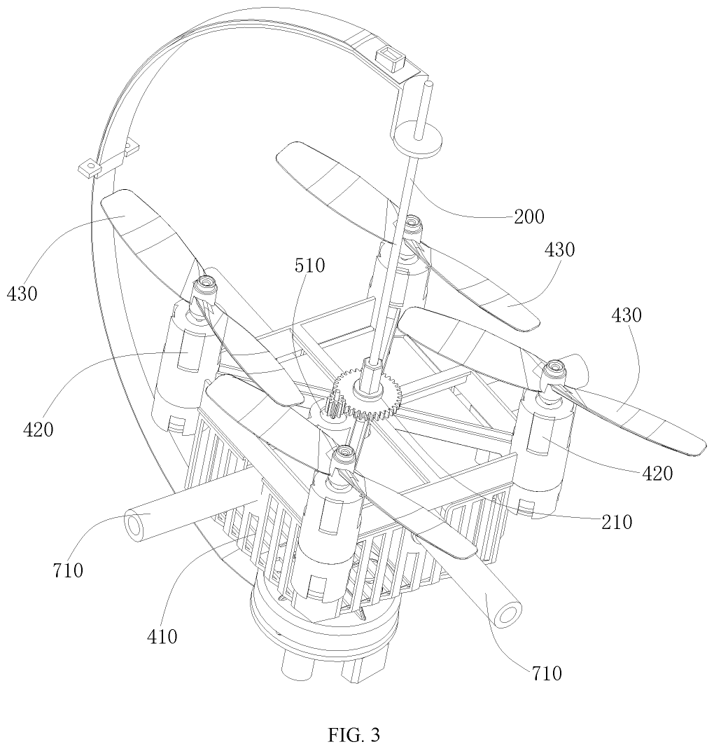

In accordance to an embodiment of the present invention, referring to FIG. 1 and FIG. 3, both ends of the driving shaft 200 are connected respectively with the inner wall of the cover 100. The driving shaft 200 is also fixed with a drive gear 210, driven by the driving assemble 500. An inner side of the drive gear 210 is against with another side of the flight assemble 400. With the drive gear 210, the flight assemble 400 is defined between the drive gear 210 and the electric control board 300, with the position of the drive gear 210 on the driving shaft 200, the position of the flight assemble 400 on the driving shaft 200 can be adjusted, thereby adjusting the center of gravity and stability of the rotary aircraft and solving the troublesome adjustment problems in the existing technique.

In accordance to another embodiment of the present invention, referring to FIG. 1 and FIG. 2, the driving shaft 200 passes longitudinally across the flight assemble 400, the light bar 600 is a long strip and longitudinally arranged.

In accordance to another embodiment of the present invention, referring to FIG. 7, the driving shaft 200 passes transversely across the flight assemble 400, the light bar 600 is a long strip and transversely arranged.

In accordance to another embodiment of the present invention, referring to FIG. 1 and FIG. 2, the light bar includes multiple display lights 610, each coupled electrically with the display control module 620, which is used to control the display of the display lights 610.

Each of the display lamps 610 is oriented toward the exterior of the cover. The light bar 600 is mounted on the outside of the cover 100 or embedded in the cover 100 so that the light bar 600 and the cover 100 rotates synchronously. The cover 100 does not block the light projected from the display light 610, which resolves the problem that the cover 100 blocks the light and then affects the effect of the projection from the light.

In accordance to another embodiment of the present invention, referring to FIG. 1 to FIG. 3, the flight assemble 400 includes a shell 410, at least a motor 420 and at least a blade 430. A first side of the shell 410 is connected with the connector 840, a second side of the shell 420 is against with an inner side of the drive gear 210. The driving assemble 500 is mounted on the shell 410, the motor 420 is mounted on the shell 410 and coupled electrically with the main control chip. The motor 420 is connected with the blade 430 to drive it to rotate, the blade 430 rotates to generate air flow to achieve the flight of the rotary aircraft.

In accordance to another embodiment of the present invention, referring to FIG. 3, the number of the motor 420 is four, arranged respectively at the four corners of the shell 410, and improving the stability of the flight. The number of the blade is four. The shell 410 is hollow out to reduce weight.

In accordance to another embodiment of the present invention, referring to FIG. 2, the cover 100 is in a ball shape, which includes an upper cover 110 and a lower cover 120. The upper cover 110 and the lower cover 120 are connected detachably. The driving shaft 200, the electrical control board 300 and the flight assemble 400 and the driving assemble 500 are arranged between the upper cover 110 and the lower cover 120.

The light bar 600 is mounted on the upper cover 110 or the lower cover 120, or both of them.

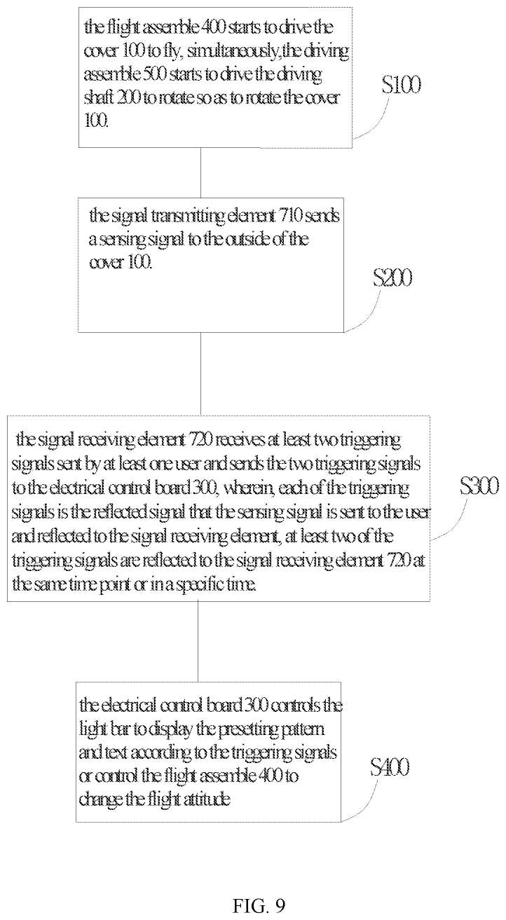

In accordance to another embodiment of the present invention, referring to FIG. 9, the present invention provides an interactive method, which includes the following steps:

Step S100, the flight assemble 400 starts to drive the cover 100 to fly, simultaneously, the driving assemble 500 starts to drive the driving shaft 200 to rotate so as to rotate the cover 100.

Step S200, the signal transmitting element 710 sends a sensing signal to the outside of the cover 100.

Step S300, the signal receiving element 720 receives at least two triggering signals sent by at least one user and sends the two triggering signals to the electrical control board 300, wherein, each of the triggering signals is the reflected signal that the sensing signal is sent to the user and reflected to the signal receiving element, at least two of the triggering signals are reflected to the signal receiving element 720 at the same time point or in a specific time.

Step S400: the electrical control board 300 controls the light bar to display the presetting pattern and text according to the triggering signals or control the flight assemble 400 to change the flight attitude.

When the signal receiving element 720 receives at least two of the triggering signals sent by at least one user, the electrical control board 300 controls the lighter bar 600 to display the presetting pattern and text, the triggering signals can be generated by a user to waving his two hand respectively or by the user to wave one hand continuously in a specific time, or two or more users to generate one triggering signal respectively at the same time, so that the interaction with the aircraft can be achieved by more actions of one user and the simultaneous actions of multiple users, which improves the enjoyment of the rotary aircraft and satisfy the demands of the user.

Wherein, the specific time may be 3 seconds, 5 seconds or other times. The action of the user includes, but are not limited to, waving both hands, and other actions can be set as desired to generate a trigger signal.

The above are only better embodiments of the invention and are not used to limit the invention, and any modifications, equivalent replacements, and improvements made within the spirit and principles of the invention shall be included within the protection of the invention. The above are only better embodiments of the invention and are not used to limit the invention, and any modifications, equivalent replacements, and improvements made within the spirit and principles of the invention shall be included within the protection of the invention.

What is claimed is:

1. A rotary aircraft, comprising a cover, a driving shaft in said cover, an electric control board on said cover, wherein, also comprising
a flight assembly, mounted on said driving shaft and coupled electrically with said electrical control board;
a driving assemble, mounted on said flight assembly and coupled electrically with said electrical control board, connected with said driving shaft and driving it to rotate so as to rotate said cover; and,
a light bar, mounted on said cover and coupled electrically with said electrical control board, used for displaying a presetting pattern or text when said cover rotates or does not rotate.

2. The rotary aircraft according to claim 1, wherein also comprising a signal transmitting element and a signal receiving element both coupled electrically with said electrical control board; said signal transmitting element may be mounted on said cover, said light bar or said fight assemble; said signal receiving element is mounted on said fight assemble.

3. The rotary aircraft according to claim 1, wherein said electrical control board is provided with a control circuit which is coupled electrically with all of said light bar, said signal transmitting element, said signal receiving element, said flight assemble and said driving assemble; a surface, facing to said flight assemble, of said electrical control board is provided with a continuous conductive unit and an intermittent conductive unit, both coupled electrically with said control circuit; said continuous conductive unit is matched with a first elastic conductive unit, when said cover drives said electric control board to rotate, said first elastic conductive unit is always against with said continuous conductive unit; said intermittent conductive unit is matched with a second elastic conductive unit, when said cover drives said electric control board to rotate a circle, said second elastic conductive unit contacts said intermittent conductive unit at least once; said first elastic conductive unit and said second elastic conductive unit both are mounted in said flight assemble and are coupled with a supply power mounted on said flight assemble.

4. The rotary aircraft according to claim 3, wherein also comprising a connector mounted on a side of said flight assemble, both of said first elastic conductive unit and said second elastic conductive unit are mounted a connector.

5. The rotary aircraft according to claim 3, wherein said connector includes a mounting plate and a connecting rod with a first end and a second end; said first end of said connecting rod is connected with an outside of said flight assemble, said second end of said connecting rod is connected with said mounting plate; said mounting plate is provided with a first mounting position where said first electrical conductive unit is mounted and a second mounting position where said second electrical conductive unit is mounted.

6. The rotary aircraft according to claim 1, wherein said electrical control board is provided with a control circuit and a first wireless communication interface coupled electrically with said control circuit; said light bar is provided with a display control module and a second wireless communication interface and a power supply; said second wireless communication interface is coupled electrically with said display control module; said power supply is coupled electrically with said display control module and said second wireless communication interface; said second wireless communication interface and said first wireless communication interface are communication connection.

7. The rotary aircraft according to claim 1, wherein two ends of said driving shaft are connected respectively with an inner wall of said cover; said driving shaft is also fixed with a drive gear, driven by said driving assemble; an inner side of said drive gear is against with a side of said flight assemble.

8. The rotary aircraft according to claim 1, wherein said driving shaft passes longitudinally across said flight assemble.

9. The rotary aircraft according to claim 1, wherein said driving shaft passes transversely across said flight assemble.

10. An interactive method of said rotary aircraft according to claim 1, wherein comprising said follow steps:
Step S100: said flight assemble starts to drive said cover to fly, simultaneously, said driving assemble starts to drive said driving shaft to rotate so as to rotate said cover;
Step S200: a signal transmitting element sends a sensing signal to an outside of said cover;
Step S300: a signal receiving element receives at least two triggering signals sent by at least one user and sends said two triggering signals to said electrical control board; each of said triggering signals is said reflected signal that said sensing signal is sent to said user and reflected to said signal receiving element, at least two of said triggering signals are reflected to said signal receiving element at the same time point or in a specific time;
Step S400: said electrical control board controls said light bar to display said presetting pattern and text according to said triggering signals or control said flight assemble to change flight attitudes.
